(19) United States
(12) Patent Application Publication
(10) Pub. No.: US 2026/0169435 A1
(43) Pub. Date: Jun. 18, 2026

(54) WATCHCASE WITH DUAL-FUNCTION BEZEL

(71) Applicant: Certina S.A., Le Locle (CH)

(72) Inventors: Anthony SIPP, Domdidier (CH); Steeve GERBER, La Neuveville (CH); Philippe SCHERRER, Delémont (CH); Nicolas EHRSAM, Evilard (CH)

(73) Assignee: Certina S.A., Le Locle (CH)

(21) Appl. No.: 19/404,430

(22) Filed: Dec. 1, 2025

(30) Foreign Application Priority Data
Dec. 13, 2024 (EP) 24219880.2

(51) Int. Cl. G04B 19/28; G04B 19/22

(52) U.S. Cl. CPC G04B 19/286; G04B 19/223

(57) ABSTRACT

A watchcase (100) including a first bezel (1) and a second bezel (2) that are coaxial around the same axis (D), including a mechanism for rotationally bolting the second bezel (2) which is in a fixed axial position in the direction of the axis (D) and which is unbolted by axial pressure by a user, in the direction of the axis (D), on the first bezel (1) to unbolt the second bezel (2) and rotate it under the effect a rotational movement imparted by the user to the first bezel (1), this bolting mechanism including an annular spring (5) that is substantially circular around the axis (D) and which is in permanent contact with the first bezel (1), on one hand, and the second bezel (2) on the other hand. The invention also relates to a watch (1000) including such a case (100).

### CROSS-REFERENCE TO RELATED APPLICATIONS

This application claims priority to European Patent Application No. No 24219880.2, filed on Dec. 13, 2024, the entire contents of which are incorporated herein by reference.

### TECHNICAL FIELD OF THE INVENTION

The invention relates to a watchcase comprising a multifunction bezel, comprising a first bezel and a second bezel coaxial around the same bezel axis.

The invention also relates to a timepiece, in particular a watch, comprising such a watchcase.

The invention relates to the field of display mechanisms for timepieces.

### TECHNOLOGICAL BACKGROUND

Horology display mechanisms require some manipulation on the part of the user, particularly in the case of diving watches, multi-time zone watches and the like. Such manipulation is not always easy in a professional environment in which the user is wearing protective equipment such as gloves, or is exposed to particular thermal stresses.

In such cases, it is preferable to limit, or better yet avoid, any manipulation of the watch crown.

### SUMMARY OF THE INVENTION

The invention proposes to equip a horology part, in particular a watch, comprising several display functions, with simple display setting means requiring little manipulation and allowing such manipulation to be carried out on amply dimensioned contact surfaces.

The proposal consists of equipping the timepiece with a multifunction bezel, comprising a first bezel that can be manipulated directly by the user, with manipulations limited to axial pressure and rotation, and a second bezel controlled by these user manipulations.

To this end, the invention relates to a watchcase according to claim 1. The term “watchcase” is taken here in its broadest sense to mean any case containing at least one horology movement.

The invention also relates to a timepiece, in particular a watch, comprising such a watchcase.

### BRIEF DESCRIPTION OF THE FIGURES

The purposes, advantages and characteristics will be better understood on reading the following detailed description, with reference to the accompanying figures, in which:

FIG. 1 is a schematic, partial, exploded perspective view of a watch comprising a watchcase according to the invention, comprising a dual-function bezel. This bezel comprises a first bezel, in this case an outer bezel, that is rotationally mobile around a bezel axis, and also mobile in axial translation in the direction of this axis, under the effect of a compressive stress applied by the user and symbolised by an arrow; this compressive stress being exerted against a first spring turned in the case middle. The bezel comprises a second bezel that is rotationally mobile only and has no axial freedom. An annular spring is also turned in the middle, inside this first spring, and this annular spring engages by bearing both on the lower part of the first bezel, and on the lower part of the second bezel, in this case an inner bezel, comprising bolting toothing. The annular spring comprises both leaf springs with a bolting function and other leaf springs with a rotational function; details show a particular embodiment in which the first bezel and the second bezel comprise complementary drive means, which can engage when the first bezel is fully pressed in;

FIG. 2 schematically shows, in cross-section through the axis of rotation of the bezel, the engagement between the first bezel, the first spring, the second bezel and the annular spring, when the first bezel is in a lock position in which the first spring is in its fully extended position and the second bezel is rotationally bolted;

FIG. 3, like FIG. 2, shows the same components, in the fully pressed-in manipulation position of the first bezel, with maximum compression of the first spring. The second bezel can then be rotated by a rotation imparted to the first bezel by the user;

FIG. 4 shows a schematic view of a first variant of the annular spring, allowing the second bezel to rotate in one direction only, and well suited for use in a diving watch;

FIG. 5, like FIG. 4, shows a second variant of the annular spring, allowing the second bezel to be rotated in both directions, for use, for example, in a multi-time zone watch;

FIGS. 6 and 7 show, in simplified form, the positions of the components in FIGS. 2 and 3, with the leaf springs on the annular spring not shown.

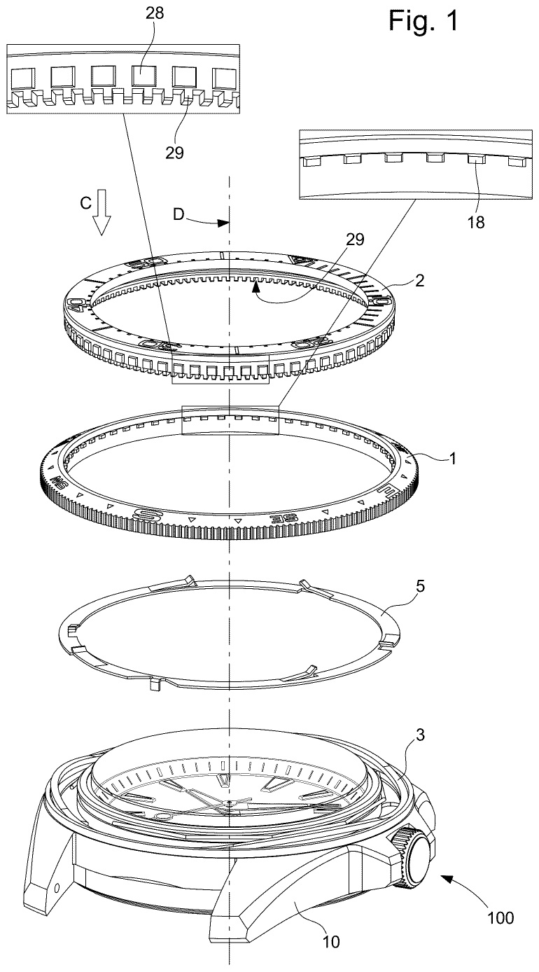

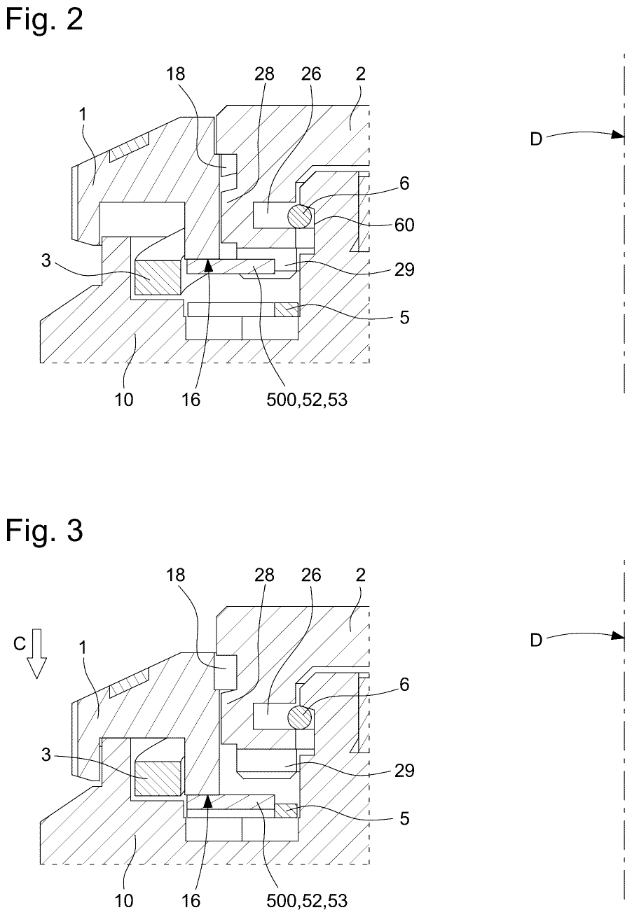

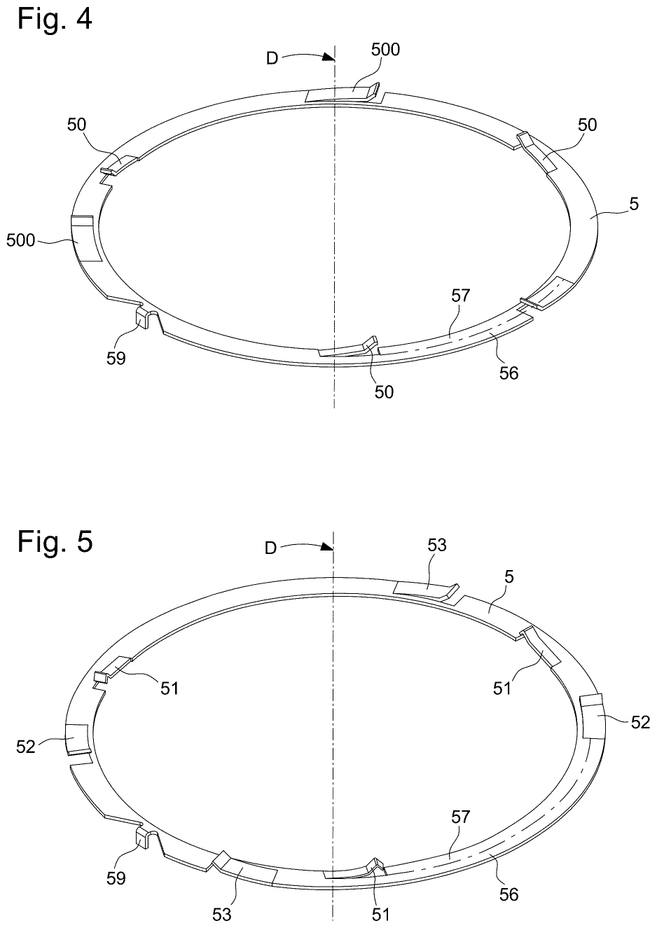

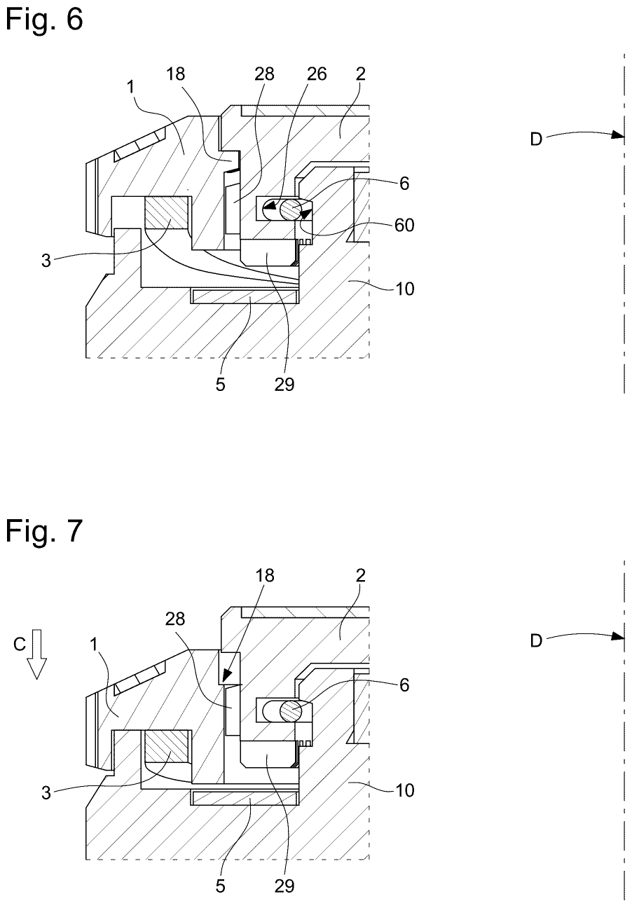

### DETAILED DESCRIPTION OF THE INVENTION

The invention relates to a watchcase 100 comprising a multifunction bezel, comprising a first bezel 1 and a second bezel 2 coaxial around the same bezel axis D.

According to the invention, the case 100 comprises a mechanism for rotationally bolting the second bezel 2 in a fixed axial position in the direction of the bezel axis D.

This second bezel 2 can be unbolted by a user pressing axially, in the direction of the bezel axis D, on the first bezel 1 to unbolt the second bezel 2 and rotationally drive it under the action of a rotational movement imparted by the user to the first bezel 1.

And the bolting mechanism comprises an annular spring 5 that is substantially circular around the bezel axis D, and which is in permanent contact with the first bezel 1 on one hand, and the second bezel 2 on the other.

The invention is illustrated in the particular, non-limiting case in which the first bezel 1 is an outer bezel and the second bezel 2 is an inner bezel.

More specifically, the first bezel 1 and the second bezel 2 are fitted on a middle 10, pivoting around the bezel axis D and rotationally independent of each other. The second bezel 2 is axially immobilised in the direction of the bezel axis D relative to the middle 10.

The first bezel 1 is axially mobile against a first spring 3 turned in the middle part 10, between a stable lock position in which the first spring 3 is relaxed, and a transient manipulation position in which the first spring 3 is compressed under the action of an axial stress imparted by a user to the first bezel 1 in the direction of the bezel axis D.

The second bezel 2 is mobile between bolting lock positions via an unbolted transient position.

The annular spring 5 extends between, on one hand, the middle part 10 and, on the other hand, the lower ends of the first bezel 1 and of the second bezel 2, around the bezel axis D, and is arranged to bolt the angular position of the second bezel 2 when the first bezel 1 is in its lock position, and to allow, at least in a first direction of rotation, the second bezel 2 to rotate when the first bezel 1 is in its manipulation position in which it exerts an unbolting pressure on the annular spring 5 to release the second bezel 2 and when it is subjected to a rotational movement imparted by the user.

The spring 5 is substantially flat and comprises a catch 59 for its angular indexing in a fixed position in the middle 10. The spring 5 comprises bolting and drive leaf springs, which can be produced by stamping and/or blanking and/or bending.

More specifically, the first bezel 1 comprises first drive means 18 that are arranged to engage with complementary second drive means 28 comprised in the second bezel 2 when the first bezel 1 is in its manipulation position, to rotationally drive the second bezel 2, at least in the first direction of rotation, during a rotation imparted to the first bezel 1 by the user.

More specifically, the annular spring 5 comprises, connected to each other, a first annular surface 56 arranged to engage a first lower bearing surface 16 comprised in the first bezel 1, and a second annular surface 57 arranged to engage a bolting toothing 29 comprised in the second bezel 2.

And the annular spring 5 comprises bolting leaf springs 500, 52, 53 that extend over the first annular surface 56 and over part of the second annular surface 57 and that are arranged to bolt the second bezel 2 by acting on its bolting toothing 29 when the first bezel 1 is in its lock position.

More specifically, the first bearing surface 16 is arranged so that, when a compressive stress is imparted to the first bezel 1 in its manipulation position, it compresses the bolting leaf springs 500, 52, 53 comprised in the first annular surface 56 of the annular spring 5, so as to unclip the bolting leaf springs 500, 52, 53 and allow the second bezel 2 to be rotated.

More specifically, the first annular surface 56 of the annular spring 5 comprises bolting leaf springs 500 which are all arranged to bolt the second bezel 2 in one direction only. Even more specifically, the first annular surface 56 of the annular spring 5 comprises bolting leaf springs 500 which are arranged to bolt the second bezel 2 in the clockwise direction only.

More specifically, the first annular surface 56 of the annular spring 5 comprises first bolting leaf springs 52 which are arranged to bolt the second bezel 2 in a first direction, and second bolting leaf springs 53 which are arranged to bolt the second bezel 2 in a second direction.

More specifically, the first clockwise bolting leaf springs 52 are arranged to bolt the second bezel 2 in a first clockwise direction, and the second counterclockwise bolting leaf springs 53 are arranged to bolt the second bezel 2 in a second counterclockwise direction.

More specifically, the second annular surface 57 comprises leaf springs with a rotational function 50, 51 enabling the second bezel 2 to be rotated.

More specifically, the second annular surface 57 comprises leaf springs with a rotational function 50 enabling the second bezel 2 to be rotated in a single direction of rotation.

More specifically, the bolting leaf springs 500 on the first annular surface 56 are opposite the leaf springs 50 with a single rotational function on the second annular surface 57.

More specifically, the second bezel 2 is graduated for use in a diving watch with unidirectional rotation.

In particular, the second bezel 2 carries a 360 60-minute indication.

More specifically, the second annular surface 57 comprises leaf springs with a dual rotational function 51 enabling the second bezel 2 to be rotated in both directions of rotation.

More specifically the second bezel 2 is graduated for a GMT application for time-telling in different time zones with bidirectional rotation, and carries a 360 24-hour indication.

Advantageously, the first bezel 1 can rotate freely in both directions of rotation, in its stable lock position and when the second bezel 2 is in a bolting position

More specifically, the second bezel 2 comprises a circular groove 26 around the bezel axis D, that is arranged to engage with a substantially annular resilient element 6 that is also turned in a middle groove 60 comprised in the middle 10.

In particular, the first bezel 1 shows the cardinal points.

More specifically, the first bezel 1 is an outer bezel, the second bezel 2 is an inner bezel.

Even more specifically, the first annular surface 56 is an outer annular surface, and the second annular surface 57 is an inner annular surface 57.

The invention also relates to a timepiece, in particular a watch 1000, comprising such a watchcase 100.

1. A watchcase (100) comprising a multifunction bezel, comprising a first bezel (1) and a second bezel (2) coaxial around the same bezel axis (D), characterised wherein said case (100) comprises a mechanism for rotationally bolting said second bezel (2) which is in a fixed axial position in the direction of said bezel axis (D), which is unbolted by axial pressure by a user, in the direction of said bezel axis (D), on said first bezel (1) so as to unbolt the second bezel (2) and rotate it by means of a rotational movement imparted to said first bezel (1) by the user, and wherein said bolting mechanism comprises an annular spring (5) that is substantially circular around said bezel axis (D) and that is in permanent contact with said first bezel (1), on one hand, and said second bezel (2), on the other hand.

2. The watchcase (100) according to claim 1, wherein said first bezel (1) and said second bezel (2) are fitted on a middle (10), pivoting around said bezel axis (D) and rotating independently of each other, said second bezel (2) being axially immobilised in the direction of said bezel axis (D) relative to said middle (10), wherein said first bezel (1) is axially mobile against a first spring (3) turned in said middle (10) between a stable lock position in which said first spring (3) is relaxed, and a transient manipulation position in which said first spring (3) is compressed under the action of an axial stress imparted by a user to said first bezel (1) in the direction of said bezel axis (D), wherein the said second bezel (2) is mobile between bolting lock positions via an unbolted transient position, and wherein the said annular spring (5) extends between, on one hand, said middle (10) and, on the other hand, the lower ends of said first bezel (1) and of said second bezel (2), around said bezel axis (D), and is arranged to bolt the angular position of said second bezel (2) when said first bezel (1) is in its said rest position, and to allow, at least in a first direction of rotation, said second bezel (2) to rotate when said first bezel (1) is in its said manipulation position in which it exerts an unbolting pressure on said annular spring (5) to release said second bezel (2) and when it is subjected to a rotational movement imparted by the user.

3. The watchcase (100) according to claim 1, wherein said first bezel (1) comprises first drive means (18) arranged to engage with complementary second drive means (28) comprised in said second bezel (2) when said first bezel (1) is in said manipulation position, to rotationally drive said second bezel (2), at least in said first direction of rotation, during a rotation imparted to said first bezel (1) by the user.

4. The watchcase (100) according to claim 1, wherein said annular spring (5) comprises, connected to each other, a first annular surface (56) arranged to engage a first lower bearing surface (16) comprised in said first bezel (1), and a second annular surface (57) arranged to engage a bolting toothing (29) comprised in said second bezel (2), and wherein the said annular spring (5) comprises bolting leaf springs (500, 52, 53) that extend over said first annular surface (56) and over part of said second annular surface (57) and that are arranged to bolt said second bezel (2) by acting on its said bolting toothing (29) when said first bezel (1) is in its said lock position.

5. The watchcase (100) of claim 4, wherein said first bearing surface (16) is arranged so that, when a compressive stress is imparted to said first bezel (1) in its said manipulation position, it compresses said bolting leaf springs (500, 52, 53) comprised in said first annular surface (56) of said annular spring (5), so as to unclip said bolting leaf springs (500, 52, 53) and allow said second bezel (2) to rotate.

6. The watchcase (100) according to claim 5, wherein said first annular surface (56) of said annular spring (5) comprises said bolting leaf springs (500) which are all arranged to bolt said second bezel (2) in one direction only.

7. The watchcase (100) according to claim 6, wherein said first annular surface (56) of said annular spring (5) comprises said bolting leaf springs (500) which are arranged to bolt said second bezel (2) in the clockwise direction only.

8. The watchcase (100) according to claim 5, wherein said first annular surface (56) of said annular spring (5) comprises first said bolting leaf springs (52) which are arranged to bolt said second bezel (2) in a first direction, and second said bolting leaf springs (53) which are arranged to bolt said second bezel (2) in a second direction.

9. The watchcase (100) according to claim 8, wherein said first so-called clockwise bolting leaf springs (52) are arranged to bolt said second bezel (2) in a first clockwise direction, and said second counterclockwise bolting leaf springs (53) are arranged to bolt said second bezel (2) in a second counterclockwise direction.

10. The watchcase (100) according to claim 5, wherein said second annular surface (57) comprises leaf springs with a rotational function (50, 51) enabling said second bezel (2) to be rotated.

11. The watchcase (100) according to claim 10, wherein said second annular surface (57) comprises leaf springs with a single rotation function (50) enabling said second bezel (2) to be rotated in a single direction of rotation.

12. The watchcase (100) according to claim 11, wherein said bolting leaf springs (500) on said first annular surface (56) are opposite said leaf springs (50) with a single rotational function on said second annular surface (57).

13. The watchcase (100) according to claim 11, wherein said second bezel (2) is graduated for use in a diving watch with unidirectional rotation.

14. The watchcase (100) according to claim 13, wherein said second bezel (2) carries a 360 60-minute indication.

15. The watchcase (100) according to claim 10, wherein said second annular surface (57) comprises leaf springs with a dual rotation function (51) enabling said second bezel (2) to be rotated in both directions of rotation.

16. The watchcase (100) according to claim 15, wherein said second bezel (2) is graduated for a GMT application for time-telling in different time zones with bidirectional rotation, and carries a 360 24-hour indication.

17. The watchcase (100) according to claim 2, wherein said first bezel (1) can rotate freely in both directions of rotation, in its said stable lock position and when said second bezel (2) is in a bolting position.

18. The watchcase (100) according to claim 1, wherein said second bezel (2) comprises a circular groove (26) around said bezel axis (D), that is arranged to engage with a substantially annular resilient element (6) that is also turned in a middle groove (60) comprised in said middle (10).

19. The watchcase (100) according to claim 1, wherein said first bezel (1) shows the cardinal points.

20. The watchcase (100) according to claim 1, wherein said first bezel (1) is an outer bezel, wherein said second bezel (2) is an inner bezel.

21. A watchcase (100) according to claim 4, wherein said first bezel (1) is an outer bezel, wherein said second bezel (2) is an inner bezel, said first annular surface (56) is an outer annular surface, and wherein said second annular surface (57) is an inner annular surface (57).

22. A watch (1000) comprising the watchcase (100) according to claim 1.
